(19) United States
(12) Patent Application Publication
(10) Pub. No.: US 2004/0150679 A1
(43) Pub. Date: Aug. 5, 2004

(54) Tachograph having a flat, cuboid housing and a registration device which is provided for using bundles of tachograph charts

(75) Inventor: Torsten Wahler, Bad Duerrheim (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/763,217

(22) Filed: Jan. 26, 2004

Related U.S. Application Data
(63) Continuation of application No. PCT/DE02/02690, filed on Jul. 22, 2002.

(30) Foreign Application Priority Data
Aug. 3, 2001 (DE) 201 12 945.0

(51) Int. Cl. B41J 2/01

(52) U.S. Cl. 347/1

(57) ABSTRACT

The present invention relates to a tachograph comprising a flat cuboid housing and a registration device provided for the use of tachograph chart bundles, in which, during the course of registration transport of a tachograph chart bundle, the individual tachograph charts that are fastened on a base disk by respective connecting strips and that have a cut-out section provided for the passage of a separating knife and registration elements from one tachograph chart to the tachograph chart next in the tachograph chart bundle, are gradually severed from the tachograph chart bundle by a stationary separating knife and are stacked on a stop, one edge each of the section of a tachograph chart interacting with the stop. The stop edge of a tachograph chart transported towards the stop is prevented from abutting on the chart-side end of the severed connecting strip of a chart that is already stacked on the stop.

### CROSS REFERENCE TO RELATED APPLICATIONS

The present application is a continuation of International Application Number PCT/DE02/02690, filed Jul. 22, 2002, and further claims priority to German patent application DE20112945.0, filed Aug. 3, 2001, the both of which are herein incorporated by reference.

### BACKGROUND OF THE INVENTION

The invention relates to a tachograph having a flat, cuboid housing and having a registration device provided for using bundles of tachograph charts, in which device the individual tachograph charts which are each attached to a base disk by means of connecting strips and have a sector-shaped cutout for a separating blade and the registration elements to pass through from one tachograph chart to the following tachograph chart in the bundle of tachograph charts are gradually separated from the bundle of tachograph charts by the fixedly arranged separating blade in the course of the registration conveying process of a bundle of tachograph charts, and are stacked against a stop, one edge of the cutout of a tachograph chart interacting in each case with the stop, and in which the stop edge of a tachograph chart which is conveyed against the stop is prevented from impacting against the tachograph-chart end of the cut-through connecting strip of a tachograph chart which is already located at the stop.

It is known that bundles of tachograph charts are advantageously used if a process which is of interest in its context is to be recorded over a relatively long period of time, or a better resolution of the registrations is to be achieved within a specific registration time range than would be possible with a single tachograph chart with a relatively limited registration capacity. Moreover, the operator control of a tachograph is significantly simplified by inserting bundles of tachograph charts, permitting, for example, weekly registration. The uninterrupted registration over a relatively long time period which is aimed at with a bundle of tachograph charts in which the tachograph charts are arranged in a staggered configuration with respect to one another is achieved by virtue of the fact that the registration elements of the tachograph slide off from one tachograph chart to the next in the bundle of tachograph charts after almost one rotation owing to the sector-shaped cutouts. The further registration then takes place without a time delay on a new, still unwritten tachograph chart, while the written tachograph chart which is connected by the connecting strip, for example a strip of paper, to the last tachograph chart in the registration process, or a base disk, is separated from the bundle of tachograph charts in the course of the further movement of the bundle of tachograph charts by means of a separating blade which also drops into the cutout of the written tachograph chart and is then effective between the written tachograph chart and the following one. In the further course of the process, the friction of the separated tachograph chart with the remaining residual bundle and residual bundle which continues to circulate, or its bushing which is permanently connected to the base disk, guides the separated tachograph chart against a fixed stop.

In one tachograph with a housing which is cuboid and flat, i.e. has the smallest dimension in the direction of the vertical axis, the tachograph charts or the bundles of tachograph charts, when they are arranged in the registration position, are arranged essentially horizontally, a bundle of tachograph charts being moved out of a removal/insertion position into the registration position and vice versa by means of a drawer which is guided in the housing. Owing to this design concept with a horizontal position of the bundle of tachograph charts and the separated tachograph charts, in particular owing to the fact that the separated tachograph charts rest above the rotating residual bundle, there is the risk of the tachograph chart which is at the top of the residual bundle impacting with the stop edge of its cutout against the tachograph-chart end of the connecting strip of a tachograph chart which has already been separated and is resting against the stop, especially since the edge region of the cutout on which the stop edge is located is of bent design in order to ensure that a written tachograph chart, which is thus to be separated off, can slide smoothly onto the separating blade. If the bundle of tachograph charts is subsequently conveyed onward owing to the conveying moment which then arises, such an impact leads to a time offset of the registrations, but, if the tachograph chart gets caught on the connecting strip which may not be bonded over its entire surface or may have come away at the edge, it can also lead to the bundle of tachograph charts tearing off from the driving means which are driven by the registration drive mechanism, and thus to the registration conveying operation of the bundle of tachograph charts being interrupted. The risk of the tachograph chart which is at the top in the residual bundle impacting, and ultimately becoming stuck, against the end of the connecting strip of this tachograph chart which is bonded to the previously separated-off tachograph chart is increased considerably in particular if a retainer which acts on the separated-off tachograph charts is in the region of the stop. Retaining the bundle of tachograph charts, however in particular of the written and separated-off tachograph charts, is expedient in the case of the device concept of the generic type because, owing to the low overall height of the device, the registration elements may be impeded or deactivated if the bundles of tachograph charts bulge upward due to the absorption of moisture, or the regions of the tachograph charts which adjoin the cutouts, which are weak in any case after the connecting strips have been cut through, bend upward.

### SUMMARY OF THE INVENTION

The object of the present invention is thus to improve the suitability of a tachograph which is equipped with a drawer, for using bundles of tachograph charts as recording media, in particular to ensure the functional reliability with respect to avoiding a collision of the residual bundle with a tachograph chart which has been separated off from the bundle of tachograph charts, specifically with means which are suitable for series manufacture. The means of achieving the object which has been set provides for a spacer element which is provided with a ramp to be provided, by means of which spacer element the tachograph charts which are separated off from the bundle of tachograph charts and rest against the stop are lifted off in a defined fashion from the registration plane within a specific angular range, and for the spacer element to be positioned with respect to the stop in such a way that a tachograph chart which is conveyed against the stop at the end of a registration cycle is lifted up in such a way that the stop edge of the tachograph chart comes into contact with this tachograph chart essentially between the connecting strip and the stop edge of a tachograph chart which rests against the stop. Advantageous developments of the invention are described by the subclaims which are arranged after claim 1. The solution which has been found makes it possible, despite the application of a retainer, to avoid a collision of the stop edge of the top tachograph chart of the residual bundle with the side-pointing counter to the conveying direction of the residual bundle—of that end—stuck to a separated-off tachograph chart which rests against the stop—of the connecting strip of this tachograph chart is avoided with sufficient reliability. Here, the position of the spacer element with respect to the stop which is assigned to the separated-off tachograph charts, the stroke predefined by the spacer element and the shape and the surface quality of the spacer element in such a way that it is ensured that a time offset of the registrations are selected on the tachograph chart which is still connected to the residual bundle is ruled out by this tachograph chart striking against the ramp or by the braking torque which is produced owing to the friction on the spacer element, and the connecting strip which is tensilely loaded by the lifting up of the tachograph chart does not become prematurely released or compressed but is rather cut through satisfactorily by the separating blade and correctly timed conveyance of the tachograph chart up to the sliding off of the registration elements onto the next tachograph chart in the bundle of tachograph charts is ensured. In this regard, the embodiment in which the spacer element is of concave design or mushroom-shaped design and is attached directly to the separating blade is particularly advantageous. The attachment or the formation on the separating blade is preferably carried out by means of an injection-molding technique; however, in the course of the fabrication of the separating blade it is also possible to mount an individual part which serves as a spacer element on the separating blade without appreciable additional expenditure. It is also conceivable for the spacer element to be directly removed from the separating blade blank by a punching and bending technique before the separating blade cures. On the other hand, an arrangement or formation of the spacer element which takes place independently of the separating blade, for example on the holder of the separating blade or on the registration underlying surface which is assigned to the bundles of tachograph charts is possible. Here, an embodiment with a sprung securing means, possibly also with a certain degree of adjustability of the spacer element, is expedient here.

### BRIEF DESCRIPTION OF THE SEVERAL VIEWS OF THE DRAWINGS

The invention will be explained in more detail below by means of an exemplary embodiment, in which:

FIG. 1 is a front view of a tachograph;

FIG. 2 is a plan view of the tachograph drawer;

FIG. 3 is a plan view of a bundle of tachograph charts;

FIG. 4 is a functional position, illustrated largely schematically, in which the stop edge of the top tachograph chart of the residual bundle is located directly in front of a plane which is determined by the side, facing the conveying direction, of a connecting strip of a tachograph chart which has already been separated off and is resting against the stop,

FIG. 5 is a functional position in which the registration elements have slid off from the written tachograph chart, still connected to the residual bundle, onto the tachograph chart which follows in the residual bundle and is still paraphrased,

FIG. 6 shows a section along the sectional line A in FIG. 4.

### DETAILED DESCRIPTION OF THE INVENTION

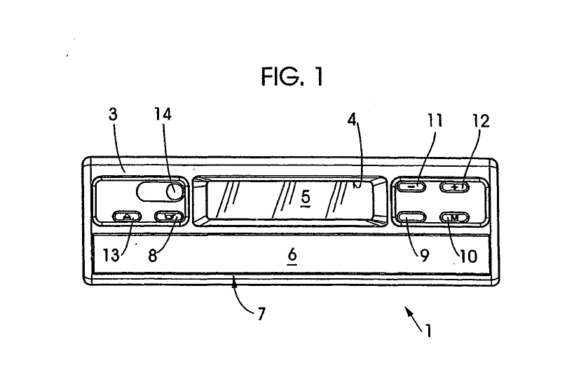

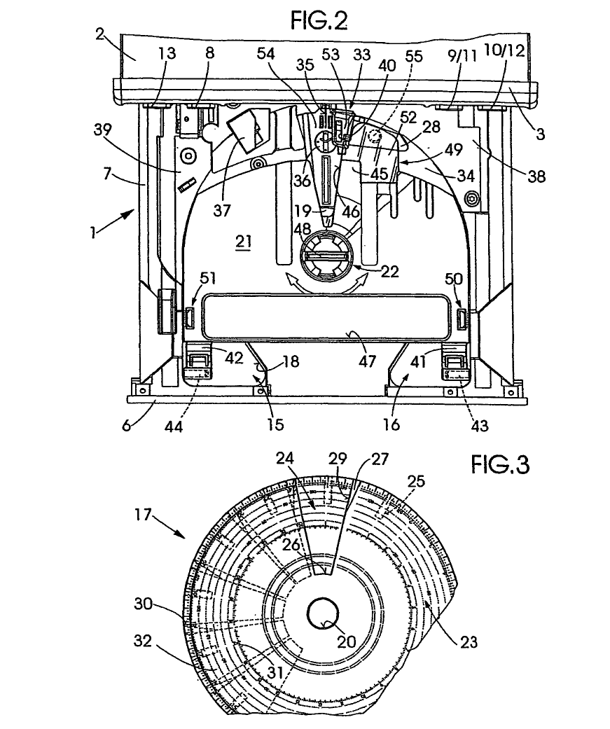

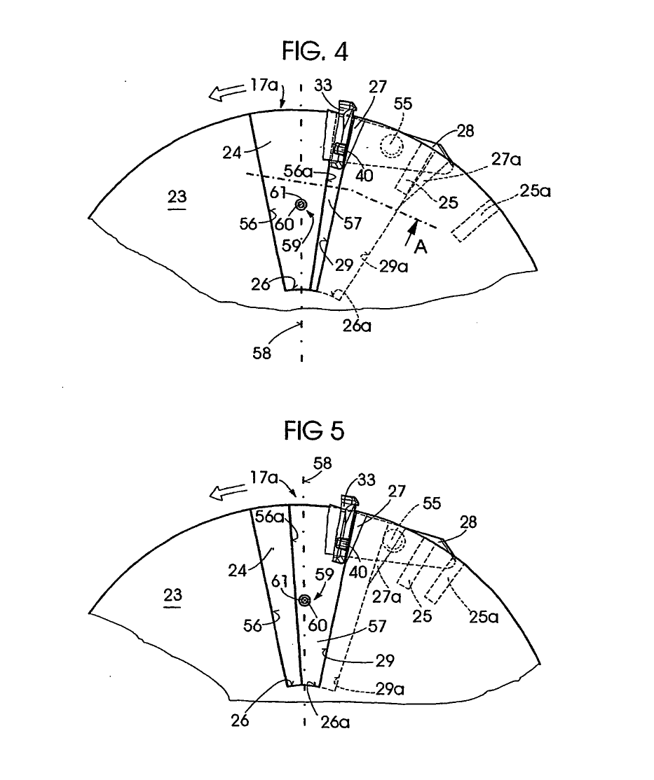

The tachograph 1 (illustrated in FIGS. 1 and 2) is embodied as a built-in device, the dimension of the vertical axis of the cuboid housing 2 (FIG. 2) which is decisive in terms of the spatial problems is approximately 50 mm. In the front panel 3, a window cutout 4 is formed for a display 5 which is assigned to the front panel 3. 6 represents the front panel of a drawer 7 which is guided in the housing 2. Of keys 8, 9, 10, 11, 12 and 13 which are mounted in the front panel 3, the keys 8 and 9 and the key 10 which is designated as a menu key is assigned to the driver or front seat passenger, for selecting at least the most important working time data items. The keys 11 and 12 are used to scroll forward and backward in the respectively selected data records, and the key 13 is provided for unlocking and releasing the drawer 7. The access to a diagnostic socket is protected by means of a lead seal which is designated by 14. Breakthroughs which are provided in the drawer 7 are designated by 15 and 16 and facilitate the removal of an inserted bundle 17 of tachograph charts (FIG. 3). 18 represents the bottom of the drawer 7. A drive mechanism which is integrated in the bottom 18 is used for driving a receiving element 19 correctly in terms of time, a bundle 17 of tachograph charts which is inserted into the drawer 7 being clamped tight onto said receiving element 19. An annular corrugated spring (not shown in FIG. 2) which is attached to the receiving element 19 and provided with driving indentations serves as an anti-rotation element. A centering pin which forms one part with the receiving element 19 is provided for aligning the bundle 17 of tachograph charts to be received, the external diameter of the centering pin corresponding to the internal diameter of a bushing 20 of the bundle 17 of tachograph charts. The bundle 17 of tachograph charts is clamped onto the receiving element 19 by a clamping element 22 which is rotatably secured on a flap 21 which is pivotably mounted in the drawer 7 acting, under the force effect of the corrugated spring, on the bushing 20 of the respective bundle 17 of tachograph charts and locking axially with the centering pin. The bushing 20 on which the individual tachograph charts of the bundle 17 of tachograph charts are mounted by means of their centering opening is known to be attached in a suitable fashion to a base disk of the respective bundle 17 of tachograph charts. In addition, as shown in FIG. 3, each individual tachograph chart of the bundle 17 of tachograph charts—the top one is designated by 23 and the next one by 24—is connected to a base disk via a connecting strip 25, preferably a paper strip. Each tachograph chart is also provided with a sector-shaped cutout 26, one edge region 27 of which is of bent-up design, thus ensuring that a separating blade 28 (FIG. 2) which is provided for cutting through the connecting strips 25 engages, after dropping into the cutout 26, under the respective top tachograph chart 23. 29 designates an edge of the sector-shaped cutout 26, which edge serves as a stop edge when the tachograph chart 23 is separated from the bundle 17 of tachograph charts. To permit the bundles 17 of tachograph charts to be inserted at the correct time and the registrations on the tachograph charts to be assigned at the correct time, the latter are provided at the edges with a timescale 30 which is repeated in a central region, for example in the zero line region 31 of the speed registration field 32. From FIG. 2 it is apparent that the separating blade 28 is attached to a holder 33, and the latter is connected to a plate-shaped support 34 which is itself arranged in a suitable way on the bottom 18 of the drawer 7. 35 represents a marking line which is provided with a clock symbol 36 and which serves to insert a bundle 17 of tachograph charts at the correct time. A structure 37 covers a photoelectric barrier which acts as an insertion control. Further covers 38 and 39 serve as dust protection and engagement protection with respect to the components of the disk drive driving the receiving element 19 which are distributed in a flat arrangement in the drawer 7. 40 designates a stop which is formed on the holder 33 and which serves the purpose of preventing the tachograph charts which are separated off from the bundle 17 of tachograph charts from circulating further as a result of friction-related driving. FIG. 2 illustrates a state in which the flap 21 is located in the closed position or clamped position without a bundle 17 of tachograph charts being inserted into the drawer 7. The flap 21 is mounted by means of two drill holes (not designated in more detail) which are formed on bearing arms 41 and 42 and to which shafts 43 and 44 which are provided in the drawer 7 are assigned. In addition, the flap 21 which is of relatively rigid construction so that it can be handled better has a gripping element 45 which is embodied in the shape of a finger and protrudes from the front face of the flap 21, a sector-shaped cutout 46 which has the purpose of allowing the registration elements of the tachograph 1 to engage through onto an inserted bundle 17 of tachograph charts, and a depression 47 which is provided for the attachment of a type plate of the tachograph 1. The clamping element 22 on which a gripping web 48 is formed at the activation end and a sleeve-shaped bayonet attachment is formed at the opposite end interacts, during its activation, with the centering mandrel, formed on the receiving element 19, with the effect of clamping tight or releasing the bushing 20 of a bundle 17 of tachograph charts. The flap 21 is, as is also apparent from FIG. 2, assigned a relatively thin elastic plate 49 which is connected to the flap 21 in a suitable way, i.e. by means of plug or joining connections which are designated globally by 50 and 51. A tongue 52 which is formed on the plate 49 serves as a retainer, in particular with respect to the written tachograph charts which are separated off from a bundle 17 of tachograph charts, the holder 33 or its surface 53 serving the tongue 52 as a support. 54 designates the surface of a registration underlying surface which is formed on the support 34 in the manner of a platform. 55 designates a spacer element which is provided as a novel feature and is assigned to the separating blade 28. FIG. 4 shows the functional position in the chronological registration process of a bundle 17 of tachograph charts, in which position it is possible for a collision to occur between a tachograph chart 23 which is separated off from the bundle 17 of tachograph charts and rests against the stop 40, and the tachograph chart 24 which is the following one in the residual bundle 17a and is still connected to the residual bundle 17a by means of the connecting strip 25a, it being possible, in particular also owing to the bent-up edge region 27a, for the stop edge 29a of the tachograph chart 24 to impact against the part of the connecting strip 25 which is bonded to the tachograph chart 23, or for it to become caught if the connecting strip is not bonded over its entire surface or has come away partially. From FIG. 4 it is also apparent that, in the illustrated functional position, the separating blade 28 has dipped in-between the tachograph charts 24 and 57 via the cutout 26a in the tachograph chart 24, and thus contributes to a certain degree of lifting up of the tachograph chart 24. The risk of it becoming stuck is in addition all the greater the more tachograph charts are separated off from the residual bundle 17a. It is also particularly large if tachograph charts which are bent as a result of absorption of moisture are held back by the tongue 52 in the direction of the residual bundle 17a. In the functional position illustrated in FIG. 4, it is at any rate absolutely necessary for the tachograph chart 24 to continue to be conveyed without disruption, i.e. without a time offset arising in the registrations, specifically until the registration elements can slide off over the edge 56a of the cutout 26a onto the tachograph chart 57 which follows the tachograph chart 24 in the residual bundle 17a. That is to say the edges 56, 56a of the cutouts 26, 26a coincide, as can also be seen in FIG. 3, with the 24-hour scale marks of the respective tachograph charts 23, 24, etc.

For the sake of completeness, it is to be noted that the registration elements of the tachograph 1—at least one for recording the speeds and one for recording distances and times—move in a plane which is at right angles to the registration face and is characterized by a dot-dash line 58, that is to say are arranged in a sprung fashion on carriages which are suitably mounted in a displaceable fashion in the housing 2 of the tachograph 1. A registration element, specifically the registration element which is provided for the speed recordings, is designated by 59 and is illustrated in cross section with respect to the speed registration field 32 of the tachograph charts 23, 24, etc. in the FIGS. 4 and 5 in a position above the zero line region 31. It is known that a holder 61, which serves to secure a sapphire tip, is provided on the stem 60 of the registration element 59.

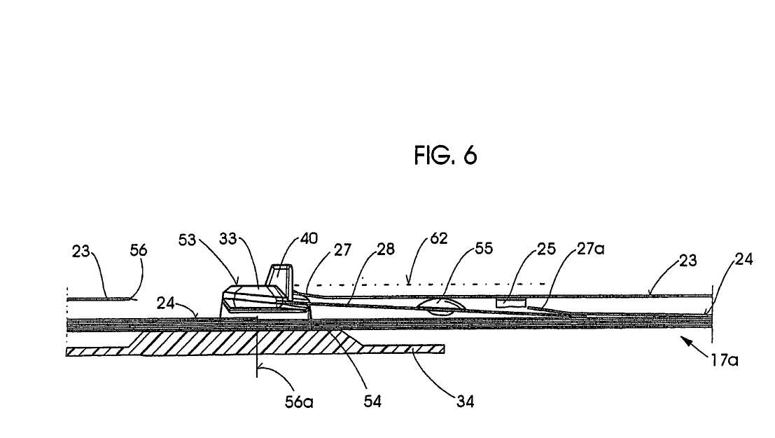

According to the section A in FIG. 4, as is apparent from FIG. 6, the spacer element 55 supports the tachograph chart 23 bearing against the stop 40, to a degree which is sufficient in the critical situation described, and thus permits the bent-up edge region 27a of the tachograph chart 24 to run through in a contact-less fashion with respect to the one end of the cut-through connecting strip 25 which is bonded to the tachograph chart 23. Then, i.e. during the further conveyance of the residual bundle 17a, the tachograph chart 24 is also lifted up by the spacer element 55 and pushed under the tachograph chart 23. The position of the spacer element 55 on the separating blade is preferably selected in such a way that the registration elements 59 have slid off onto the tachograph chart 24 before a higher torque requirement for conveying the residual bundle 17a arises as a result of the lifting up and pushing under of the tachograph chart 24. This situation occurs in the functional position according to FIG. 5, i.e. the tachograph chart 24 is largely lifted up, the registration elements 59 already register on the tachograph chart 57 which is the following one in the residual bundle 17a, and the connecting strip 25a of the tachograph chart 24 comes into contact with the cutter of the separating blade 28. Until the connecting strip 25a is cut through entirely, the tachograph chart 24 is moved by the registration drive, and dragged along after the cutting through of the connecting strip 25a by means of the friction with the residual bundle until the stop edge 29a strikes against the stop 40. In this context, it is advantageous if the tachograph chart 24 is pushed onto the spacer element 55 before the connecting strip 25a is cut through. 62 symbolically designates the level at which the tongue 52 which is formed on the plate 49 and acts as a retainer is located when it is supported on the surface 53 of the holder 33 when a bundle 17 of tachograph charts is clamped tight to the receiving element 19. In the selected exemplary embodiment, the spacer element 55 is designed as a plastic part and is attached to the separating blade 28, for example by means of ultrasonic welding or hot-heading. It is also self-evident to manufacture the spacer element 55 from brass, for example, and to rivet it to the separating blade 28. It is advantageous to form the spacer element 55 as a mushroom-shaped component insofar as it can be mounted easily and forms a ramp with a decreasing torque requirement with respect to the lifting-up of the tachograph charts.

I claim:

1. A tachograph having a flat, cuboid housing and having a registration device provided for using bundles of tachograph charts, in which device the individual tachograph charts which are each attached to a base disk by means of connecting strips and have a sector-shaped cutout for a separating blade and the registration elements to pass through from one tachograph chart to the following tachograph chart in the bundle of tachograph charts are gradually separated off from the bundle of tachograph charts by the fixedly arranged separating blade in the course of the registration conveying process of a bundle of tachograph charts, and are stacked against a stop, one edge of the cutout of a tachograph chart interacting in each case with the stop, and in which the stop edge of a tachograph chart which is conveyed against the stop is prevented from impacting against the tachograph-chart end of the cut-through connecting strip of a tachograph chart which is already located at the stop, characterized in that a spacer element which is provided with a ramp and by means of which the tachograph charts which are separated off from the bundle of tachograph charts and rest against the stop are lifted off in a defined fashion from the respective registration plane within an angular range which corresponds at least to the sector-shaped cutout of a tachograph chart, and in that the spacer element is positioned with respect to the stop in such a way that a tachograph chart which is conveyed against the stop at the end of a registration cycle is lifted up in such a way that the stop edge of the tachograph chart comes into contact with this tachograph chart, essentially between the connecting strip and the stop edge of a tachograph chart which rests against the stop.

2. The tachograph as claimed in claim 1, characterized in that the spacer element is formed directly on the separating blade.

3. The tachograph as claimed in claim 1, characterized in that the spacer element is integrally formed on the holder of the separating blade.

4. The tachograph as claimed in claim 1, characterized in that the spacer element is attached to the support, preferably in an adjustable fashion.

5. The tachograph as claimed in claim 1, characterized in that the spacer element is of concave design and is preferably attached to the separating blade by means of an injection-molding technique.

6. The tachograph as claimed in claim 1, characterized in that the spacer element is embodied as a mushroom-shaped component which can be attached to the separating blade.
